(19) United States
(12) Patent Application Publication
(10) Pub. No.: US 2011/0217424 A1
(43) Pub. Date: Sep. 8, 2011

(54) FOOD SNACK ON A STICK

(76) Inventor: MICHAEL EDWARDS, Monticello, WI (US)

(21) Appl. No.: 12/717,140

(22) Filed: Mar. 4, 2010

(51) Int. Cl. A23L 1/217

(52) U.S. Cl. 426/91

(57) ABSTRACT

A food snack for convenient consumption comprising: a substantially rectangular food composition, where said food composition includes at least shredded potatoes and Swiss cheese; a coating substance over the food composition, where the coating helps to maintain the shape and consistency of the food composition; and a stick protruding from the food composition, where the stick provides a mechanism to handle and manipulate the food composition during consumption. In one particular embodiment, the coating substance includes egg white. The stick may be made of a biodegradable product.

### BACKGROUND OF THE INVENTION

1. Field of Invention

The present invention relates to a food snack that is prepared on a stick for consumption.

2. Description of Related Art

Convenient methods of serving food items are used throughout the restaurant and food service industry. Conventionally food is served on a plate with utensils used to consume the food. However in certain instances food is served in other means and manner such as fast food restaurants who may serve food in various plastic and paper containers. Frozen foods are provided in boxes and microwavable containers. Even various plastic bags are used to package snacks such as nuts, potato chips or popcorn, also some foods are processed and placed in cans. Ready or convenient consumable food is definitely a need of modern society.

One novel means of serving food relates to food served on a stick. Examples of foods served on a stick include the use of skewers for meats or vegetables where food is served in a shish-kebab style. Corn dogs are also another example of a food product that is served on a stick where the consumer may hold the stick while consuming the edible food that is either cooked or formed on the stick itself. Frozen items served on sticks include ice cream bars and frozen popsicles.

Some food products served on a stick are directed toward children, but adults also enjoy many of these types of food products. Consuming food on a stick alleviates the necessity for utensils and/or a serving plate. Further development of food novelties are always needed in this area for the ever expanding and changing needs and likes of consumers.

### SUMMARY OF THE INVENTION

The present invention relates to a food snack for convenient consumption comprising: a substantially rectangular food composition, where said food composition includes at least shredded potatoes and Swiss cheese; a coating substance over the food composition, where the coating helps to maintain the shape and consistency of the food composition; and a stick protruding from the food composition, where the stick provides a means to handle and manipulate the food composition during consumption. In one particular embodiment, the coating substance includes egg white. The stick may be made of a biodegradable product.

### BRIEF DESCRIPTION OF DRAWINGS

FIG. 1 depicts a food snack on a stick in accordance with the present invention.

### DETAILED DESCRIPTION

The present invention relates to a novel food snack that is placed on a stick for consumption. The food product consists of a deep fried food snack made of shredded potatoes and Swiss cheese. Potatoes are consumed in various manners such as French fries, baked, potato chips, potato fries, mashed or au gratin. The present invention provides another unique means of consuming potatoes that provides for a tasty snack in a convenient manner served on a stick.

The present invention includes a mixture of potatoes, seasonings and Swiss cheese that may be frozen and deep-fried upon serving. The food product that comprises the snack on a stick may be up to 4 inches in length where it may be coated with egg white in order to retain a bond during the frying process.

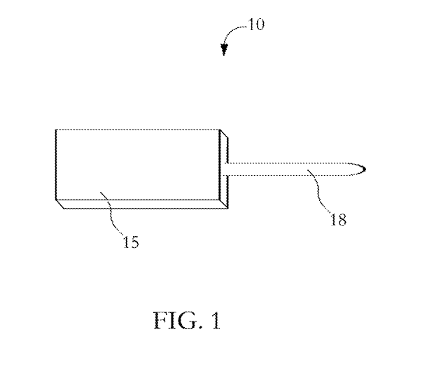

The food snack on a stick according to the present invention is a transportable and convenient snack that is depicted in FIG. 1. A food snack 10 includes a food composition 15 placed upon a serving stick 18. The food composition 15 consists of shredded potatoes and

Swiss cheese as the primary components. The food composition 15 is substantially rectangular in shape. The application of egg white on the surface of the food composition 15 ensures that food snack 10 remains in a rectangular shape during processing. The food snack 10 may be immediately fried after application of the egg white or frozen for later preparation and consumption. The food composition 15 provides a flavorful and filling food item that is conveniently placed on a stick for consumption.

The stick 18 may be made of a biodegradable material or a conventional wooden stick as food products of the prior art. The food snack 10 according to the present invention provides a combination of readily available ingredients for a flavorful and filling food item. The food snack 10 may be easily enjoyed at picnics, barbeques, carnivals, fairs or other outdoor settings. In one particular embodiment, the food composition is 4 inches in length and 2½ inches square in width and thickness. The instant invention has been shown and described in what it considers to be the most practical and preferred embodiments. It is recognized, however, that departures may be made there from within the scope of the invention and that obvious modifications will occur to a person skilled in the art.

What is claimed is:

1. A food snack for convenient consumption comprising:
a. a substantially rectangular food composition, where said food composition includes at least shredded potatoes and Swiss cheese;
b. a coating substance over the food composition, where the coating helps to maintain the shape and consistency of the food composition; and
c. a stick protruding from the food composition, where the stick provides a means to handle and manipulate the food composition during consumption.

2. The food snack according to claim 1, where said coating substance includes egg white.

3. The food snack according to claim 1, where the stick is made of a biodegradable product.

4. The food snack according to claim 1, where the food composition is 4 inches in length and 2.5 inches square in width and thickness.
